(19) United States
(12) Patent Application Publication
(10) Pub. No.: US 2008/0080696 A1
(43) Pub. Date: Apr. 3, 2008

(54) Utilizing multiple, sequential trigger detection points to enable intelligent network service call management

(76) Inventor: Stephen Keith Nicholson, Aventura, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/540,815

(22) Filed: Sep. 28, 2006

(51) Int. Cl. H04M 7/00

(52) U.S. Cl. 379/230

(57) ABSTRACT

Intelligent network service (“IN service”) may be invoked beyond initial call setup for additional call management by establishing trigger detection points that refer the call back to a service control point. Subsequent requests for IN service with respect to a particular call may be correlated with a previous request for IN service by providing correlation information to the service control point. Once correlated, information from both the earlier and later IN service requests are available to the service control point.

### BACKGROUND OF THE INVENTION

The invention described and claimed here concerns intelligent networks and call processing. Such networks are described in U.S. Pat. No. 6,101,250 and No. 6,947,541, incorporated here by reference.

### BRIEF DESCRIPTION OF THE DRAWINGS

FIG. 1 is a block diagram of a telecommunications system;

FIG. 2 is a call flow diagram;

FIG. 3 is a call flow diagram for a procedure for completing a call to voice mail over an optimized route for a subscriber roaming in another country;

FIGS. 4 and 5 are block diagrams of a telecommunications system illustrating the routing of a call to voice mail shown in the call flow diagram of FIG. 3;

FIG. 6 is a call flow diagram for a procedure for completing a call to voice mail over an optimized route for a subscriber roaming in an area served by a switch operated by another carrier;

FIGS. 7 and 8 are block diagrams of a telecommunications system illustrating the routing of a call to voice mail shown in the call flow diagram of FIG. 6.

### DESCRIPTION OF THE INVENTION

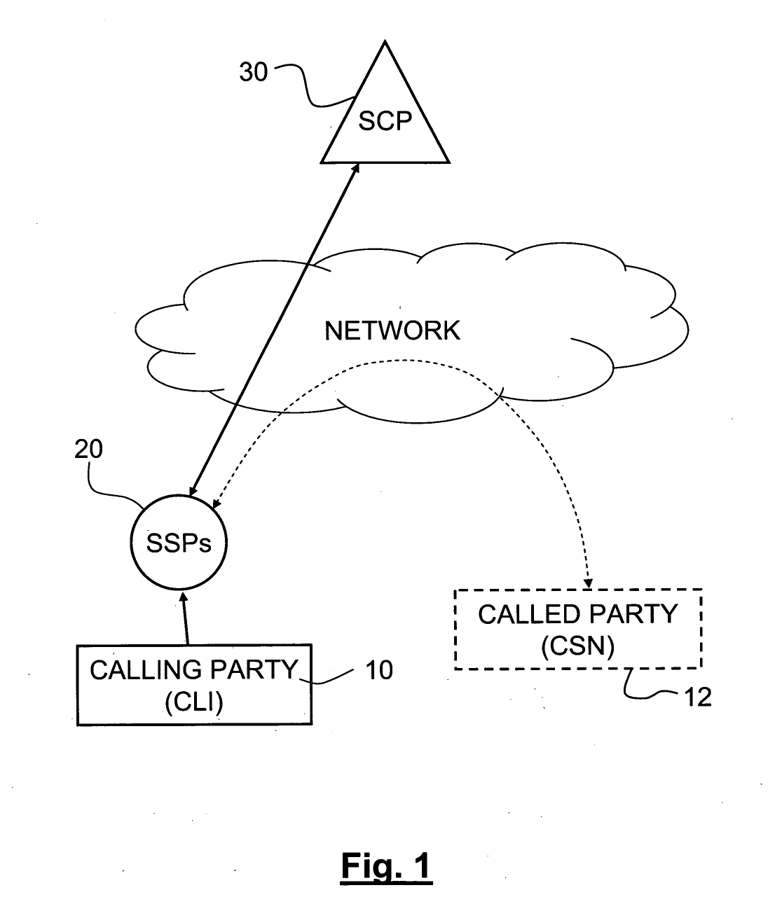

A telecommunications system serving a calling party 10 is shown in FIG. 1. The calling party 10, which may be identified by its calling line identity (CLI), initiates a call to a called party 12, entering the system via a gateway such as a service switching point (SSP) 20. The called party 12 may be identified and reached through the telecommunications system by a called subscriber number (CSN).

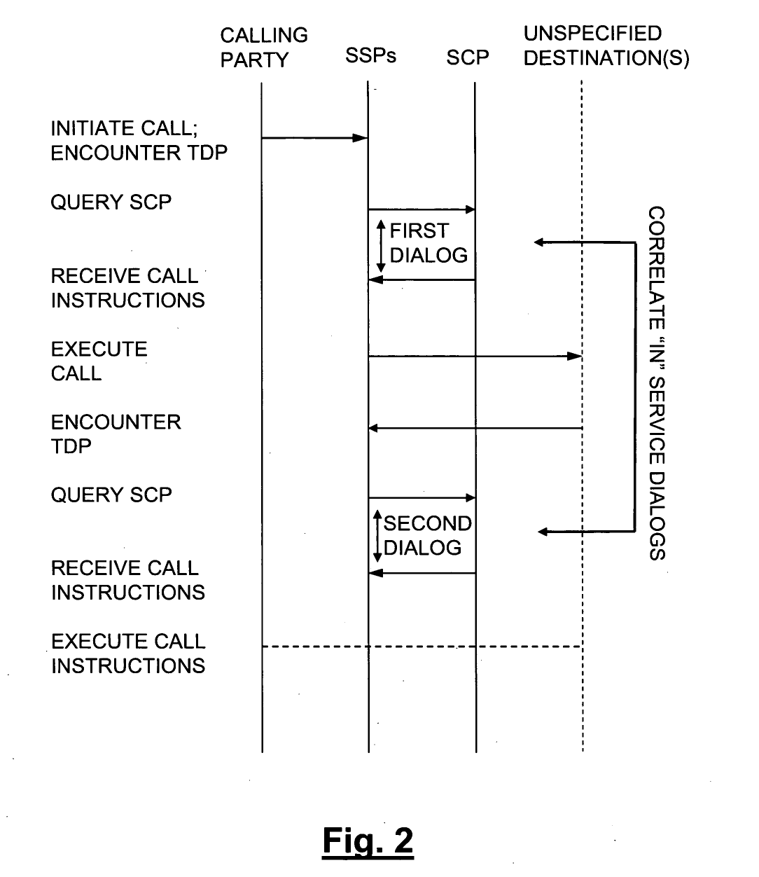

As shown in the associated call flow diagram of FIG. 2, the call encounters a previously-established first trigger detection point (TDP) at the SSP 20. The SSP 20 then queries a service control point (SCP) 30, providing information that may include the identities of the calling party (e.g., the CLI) and the called party 12 (e.g., the CSN) and invoking intelligent network service (“IN service”) as dictated by the specific trigger detection point. In response, the SCP 30 then issues instructions, such as call-processing instructions, to the SSP 20. In an alternative configuration, the SSP 20 and the SCP 30 may be realized collectively as an intelligent network service node.

In certain instances, it may be advantageous for the ongoing call to subsequently invoke the same IN service that was enabled following a previous encounter of a trigger detection point. This may be accomplished by establishing one or more additional trigger detection points. As the call proceeds, should the call trigger these additional trigger detection points, the SSP 20 again queries the SCP 30, invoking the same IN service.

A second trigger detection point encounter is shown in the fifth segment in FIG. 2. When querying the SCP 30 this additional time, the SSP 20 forwards information that enables the SCP 30 to correlate this second IN dialog with the previous one (see the bracket on the right-hand side in FIG. 2). Otherwise, the SCP 30 would treat the second request for IN service as a new, independent call. The correlation information may be an identifier assigned to the call, such as the identity of the original calling party (i.e., the CLI), typically preserved in the messaging for the duration of the call. Also, the SSP 20 may forward new or additional information to the SCP 30, as well as the identity of the specific trigger encountered.

Once the current and prior requests for IN service have been correlated, the SCP 30 can access the content of both of the dialogs, e.g., data and parameters such as the CLI, the CSN, routing, and other telephone numbers. Next, the SCP 30 provides further call processing instructions to the SSP 20, based on the information received at the SCP 30, or a combination of information gathered from other SSP-SCP interactions that follow trigger detection point encounters.

In the call flow diagram of FIG. 2, the horizontal lines representing the execution of the call are shown terminating at a dashed vertical line to representing a non-specific destination, such as a called party 12. Similarly, the origin of the call segment resulting in a trigger detection originates at the vertical dashed line—a non-specific destination, such as the called party 12 or perhaps another switch. The final execution of call instructions is shown as a dashed line to indicate that the instructions include a scenario where a call is not completed.

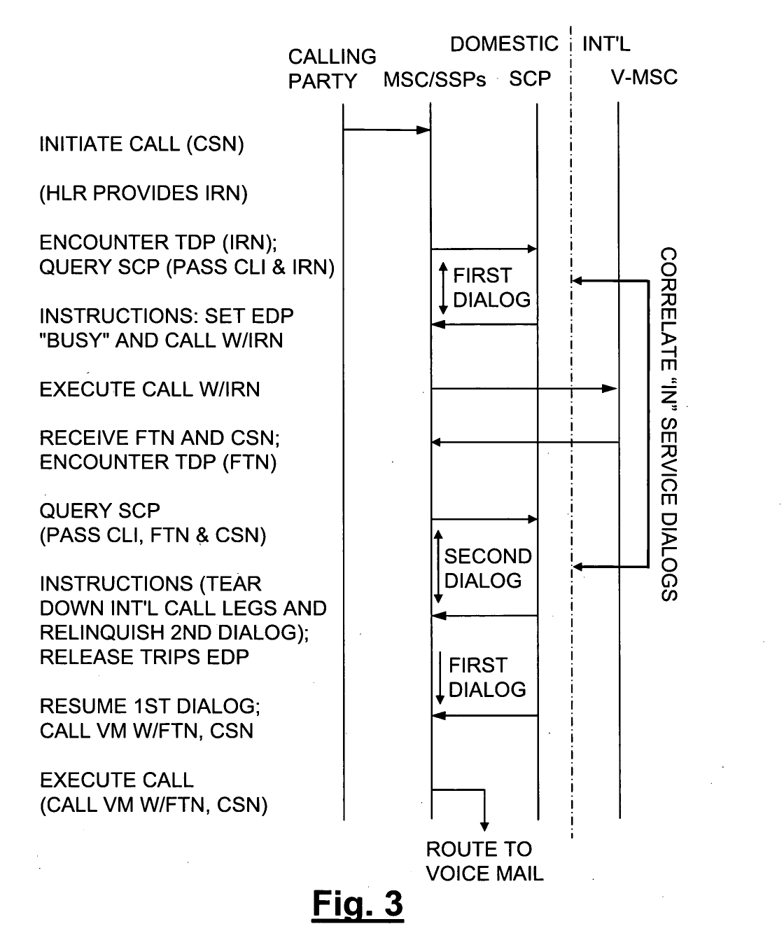

The foregoing procedure may be used to optimize routing for a call ultimately routed to voice mail. In this example, illustrated in FIGS. 3-5, the called party 12 is a wireless customer, normally physically present in the same country as that of the calling party 10, but now temporarily traveling in another country.

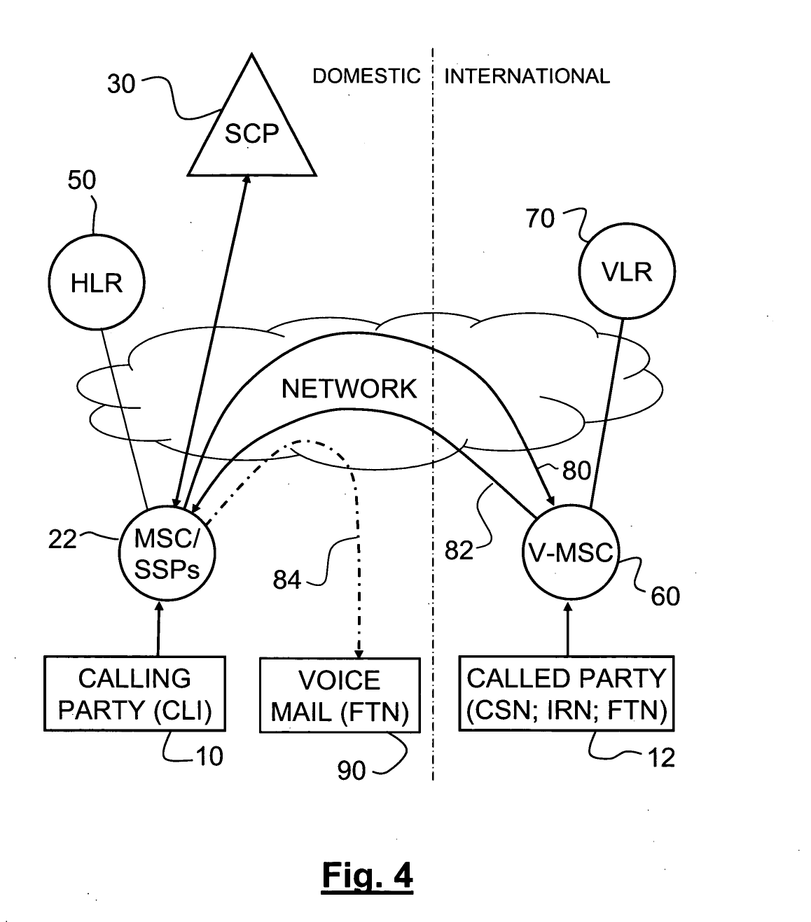

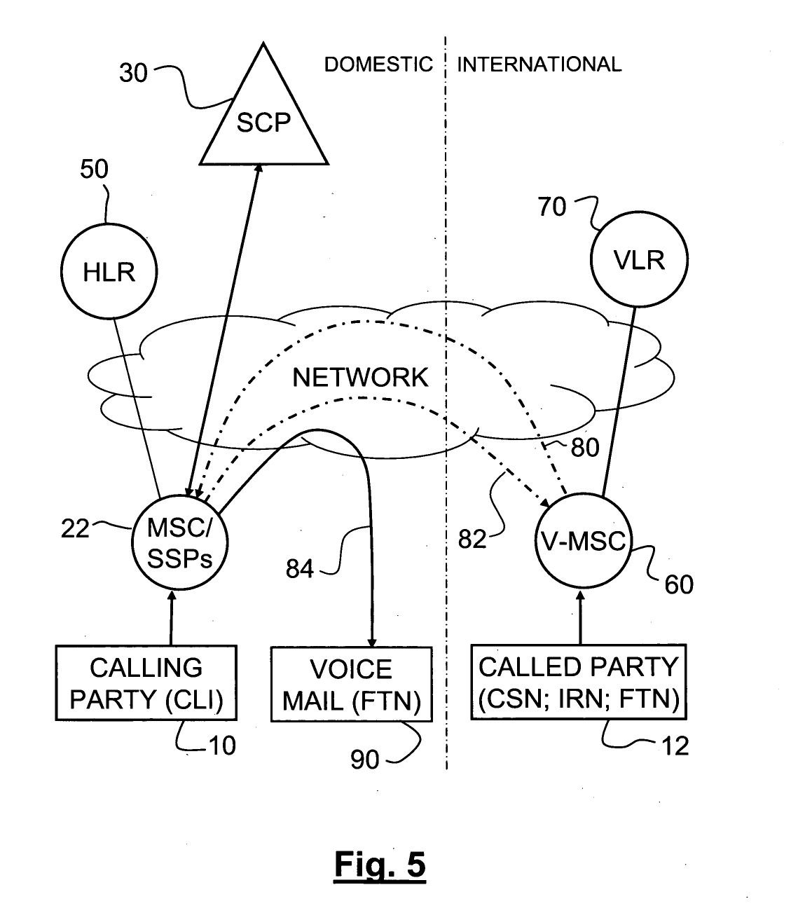

For the purpose of discussion, some of the designations of components and signaling employed are those associated with SS7 switching and GSM networks. For example, the SSP 20 is realized in FIGS. 4 and 5 as a combined mobile switching center (MSC) and SSP (MSC/SSP 22). Nevertheless, the concepts described may be applied to other switching conventions and communication modes and formats. Further, for clarity of presentation, not all of the signaling that normally accompanies the call processing discussed here is shown in the drawings or described here, but is understood to occur nevertheless as required by the protocols and procedures employed.

During initial call set up, the calling party 10 seeks to contact the called party 12 based on the latter's mobile subscriber's telephone number (the CSN). In accord with currently-employed protocols for a network of mobile subscribers, the MSC/SSP 20 queries a home location register (HLR) 50 associated with the MSC/SSP 22 to determine the status and location of the called party 12.

Since the called party 12 is roaming in a network in another country, the HLR 50 responds with a routing number such as an international routing number (IRN) for the called party, which supplants the CSN. The international routing number (IRN) is used to route the call to another mobile switching center—the visited MSC 60, located in the network where the called party 12 is now registered, and ultimately to the called party 12. When the mobile subscriber, i.e., the called party 12, initially registered with the visited MSC 60, the particulars associated with that subscriber, such as the CSN, were entered in a visitor location register (VLR) 70 associated with the visited MSC 60.

Using the international routing number (IRN) of the called party 12, the MSC/SSP 22 then initiates the call, encountering a trigger detection point responsive to international routing numbers and commencing a first dialog with the SCP 30 (FIG. 3). The MSC/SSP 22 queries the SCP 30, passing the calling party's CLI and the called party's IRN to the SCP 30.

The SCP 30 responds with call processing instructions, directing the MSC/SSP 22 to proceed with the call and begin setting up an outbound international call leg 80. Also, the SCP 30 directs the MSC/SSP 22 to arm an event detection point (EDP) for a “busy” condition. As discussed below, this will enable the MSC/SSP 22 to maintain the original call leg from the calling party 10.

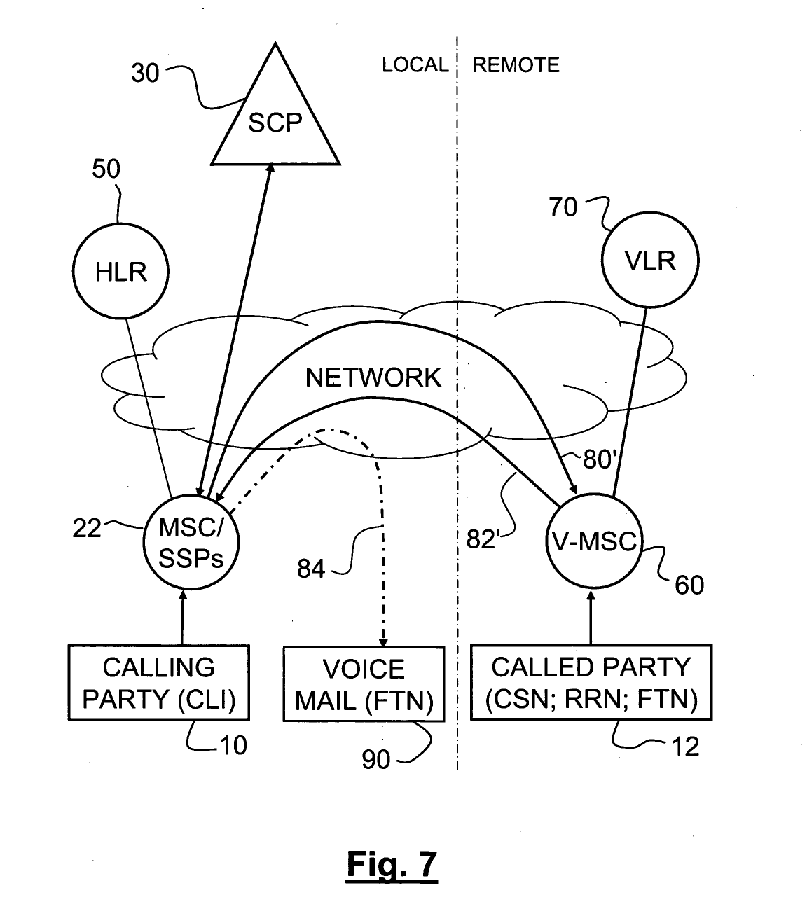

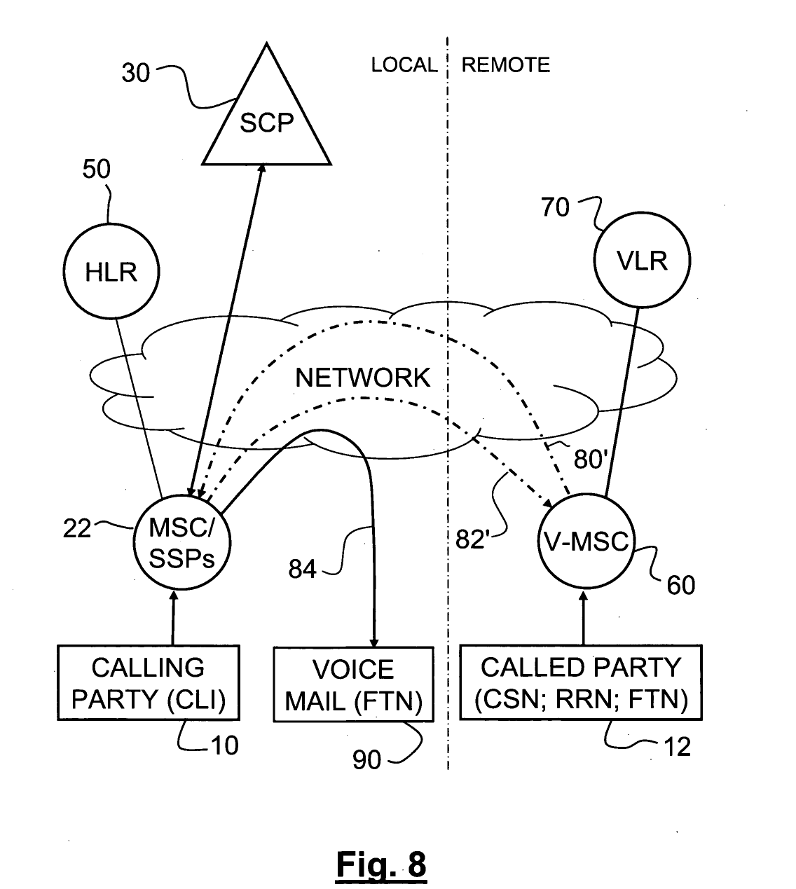

Should the called party 12 not answer, after a predetermined period of time the visited MSC 60 will forward the call, i.e., redirect the call, to the called party's home network (MSC/SSP 22) over a return international call leg 82. Since the forwarded call is returning to the called party's home network, it now contains the called party's number—the CSN (recovered from the visited MSC 60), as well as the number for voice mail as the destination, arbitrarily designated here as the “forward to number” (FTN, e.g., the voice mail group number). (Although FIGS. 4 and 5 show the return call leg 82 connected to the same MSC/SSP 22 as the outbound call leg 80, this is only for purposes of clarity. The domestic side of the network typically has multiple switches and therefore the return call leg 82 would likely connect to a different MSC/SSP. Consequently, the MSC/SSP 22 in these figures should be understood to represent multiple switches and are indicated in the plural in the drawings: “SSPs” in FIGS. 1 and 2 and MSC/SSPs in FIGS. 3-8.) If the forwarded call was allowed to go to completion (via a third call leg 84—shown dashed in FIG. 4—from the MSC/SSP 22 to voice mail service 90), the called party 12 would incur charges for the two international call legs 80 and 82 along with an international roaming fee. Instead, call completion is suspended when the forwarded call encounters a trigger detection point at the MSC/SSP 22 (triggering, e.g., on the voice mail group number), commencing a second dialog between the MSC/SSP 22 and SCP 30.

The MSC/SSP 22 queries the SCP 30, again invoking the intelligent network service, providing the SCP 30 with the voice mail group number (the FTN), the calling party's CLI, and the called party's CSN. Previously not available to the MSC/SSP 22 after the call was first initiated since the HLR 50 replaced it with the international routing number (IRN), the CSN was extracted from the call forwarded by the visited MSC 60.

Utilizing the calling party's CLI, the SCP 30 then correlates this second dialog with the first. In this second dialog, the SCP 30 instructs the MSC/SSP 22 to tear down (i.e., release with reason “busy”) the two international call legs 82 (the return) and 80, back to the MSC/SSP 22. The process of tearing down the international call legs encounters the previously-armed event detection point at the MSC/SSP 22, suspending further call processing, leaving the circuit from the calling party 10 to the MSC/SSP 22 intact and relinquishing the second dialog (note dashed lines 80 and 82 in FIG. 5). Since no voice circuits were completed (i.e., prior to an answer condition), no charges are incurred for setting up the outbound and return call legs 80 and 82.

The SCP 30 now resumes the first dialog, instructing the MSC/SSP 22 to the route the call directly to the voice mail service 90 on call leg 84, providing the MSC/SSP 22 with the voice mail group number (the FTN) as the destination and the called party's number (the CSN) used to identify the specific subscriber's voice mail box within the voice mail service 90.

The foregoing procedure may also be used to avoid roaming charges that are incurred within the same country. For example, a wireless provider may offer service within a relatively small geographical area, perhaps within a single state. Should one of provider's subscriber be roaming in an area served by another carrier, an unanswered call to the subscriber would be forwarded to voice mail. Although there would be no charges for international call legs, the subscriber would incur roaming charges and perhaps long distance charges as well.

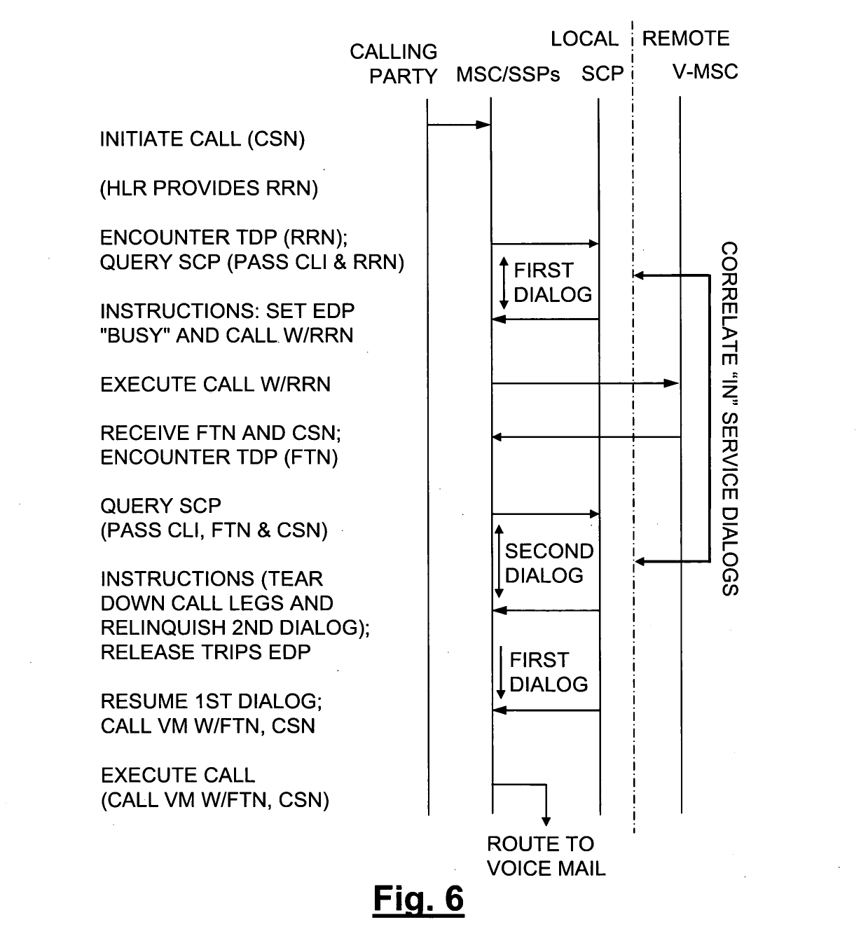

To avoid such roaming and long distance charges, the provider could establish trigger detection points that invoke intelligent network service and prevent call completion through the remote switch (FIGS. 6-8). One possible trigger could be the subscriber's remote routing number (RRN). When the call to the voice mail group number is received from a remote switch operated by the other carrier, i.e., the visited MSC, the second dialog would be invoked. As with the international case, the call legs back to the visited MSC (82′) and then back to the original MSC/SSP (80′) would be torn down. Finally, the call would be routed directly from the MSC/SSP to voice mail service.

What is claimed is:

1. A method for managing a call from a calling party to a called party in a telecommunications system comprising intelligent network service capability, comprising:
establishing a plurality of trigger detection points for an intelligent network service;
encountering a first trigger detection point for the intelligent network service and, in response to encountering the first trigger detection point, invoking a first intelligent network service dialog;
in response to the first dialog, executing a call and encountering a second trigger detection point for the intelligent network service;
in response to encountering the second trigger detection point, invoking a second intelligent network service dialog, where invoking a second dialog comprises providing correlation information associated with the first intelligent network service dialog;
in response to the second intelligent network service dialog and the correlation information, correlating the second intelligent network dialog with the first intelligent network dialog; and
in response to the second dialog, executing call instructions.

2. A method as set forth in claim 1, where correlating comprises correlating the second dialog with the first dialog based on the identity of the calling party.

3. A method as set forth in claim 1, where correlating comprises providing access to the content of the first and second dialogs.

4. A method as set forth in claim 1, further comprising encountering a subsequent trigger detection point.

5. A method for correlating intelligent network service requests in a telecommunications system, comprising:
invoking an intelligent network service dialog;
receiving correlation information associated with a prior intelligent network service dialog; and
in response to the correlation information, correlating the intelligent network dialogs.

6. A method as set forth in claim 5, where correlating the intelligent network dialogs comprises correlating the intelligent network dialogs based on the identity of a calling party.

7. A method as set forth in claim 5, where correlating the intelligent network dialogs comprises providing access to the content of the prior dialog.

8. A method for managing a call, in a telecommunications system comprising intelligent network service capability, from a calling party, comprising a calling line identity, to a mobile called party, registered in a remote switch and comprising a called subscriber number and a routing number, where the called party does not answer the call, comprising:
establishing a plurality of trigger detection points comprising a first trigger detection point responsive to a request to initiate a call to a routing number and a second trigger detection point responsive to a request to initiate a call to voice mail with a voice mail group number received from a remote switch;
initiating a call to the mobile called party, where initiating comprises placing a call to the routing number;
encountering the first trigger detection point and, in response to encountering the first trigger detection point, invoking a first intelligent network service dialog, where invoking the first dialog comprises providing identifying information;
in response to the first dialog, executing a call to the routing number, where executing the call comprises establishing an outbound call leg;
redirecting the call to the voice mail group number, where redirecting the call comprises establishing a return call leg;
encountering the second trigger detection point;
in response to encountering the second trigger detection point, invoking a second intelligent network service dialog, where invoking a second dialog comprises providing correlation information associated with the first intelligent network service dialog, the voice mail group number, and the called subscriber number;
in response to the second intelligent network service dialog and the correlation information, correlating the second intelligent network dialog with the first intelligent network dialog;
tearing down the outbound and return call legs and relinquishing the second dialog;
resuming the first dialog, and providing the voice mail group number and the called subscriber number;
executing a call to the voice mail group number; and
passing the called subscriber number to voice mail.

9. A method as set forth in claim 8, where correlating the second intelligent network dialog with the first intelligent network dialog comprises providing access to the content of the first and second dialogs.

10. A method as set forth in claim 8, where invoking a second dialog further comprises extracting the called subscriber number from the redirected call arriving on the return call leg.

11. A method as set forth in claim 8, where
in response to the first dialog, further comprising arming an event detection point; and
where tearing down comprises
tearing down with release reason “busy;”
detecting the event detection point;
suspending further processing; and
relinquishing the second dialog.

12. A method as set forth in claim 11, where arming an event detection point comprises arming an event detection point for a condition suspending further processing.

13. A method as set forth in claim 11, where arming an event detection point comprises arming an event detection point for the condition “release,” reason “busy.”

14. A method as set forth in claim 8, where
the remote switch is a switch in another country; and
the routing number is an international routing number.

15. A method as set forth in claim 8, where
the remote switch is a switch operated by another carrier; and
the routing number is a remote routing number.

16. A method for correlating intelligent network service requests in a telecommunications system, comprising:
receiving a call from a remote switch to a voice mail group number for a mobile party registered in the remote switch;
encountering a trigger detection point responsive to a call from the remote switch to the voice mail group number;
in response to the trigger detection point, invoking an intelligent network service dialog and passing correlation information; and
in response to the correlation information, correlating the intelligent network dialog with a prior intelligent network dialog.

17. A method as set forth in claim 16, where correlating the intelligent network dialog with a prior intelligent network dialog comprises correlating the intelligent network dialogs based on the identity of a calling party.

18. A method as set forth in claim 16, where correlating the intelligent network dialog with a prior intelligent network dialog comprises providing access to the content of the prior dialog.

19. A method as set forth in claim 16, where receiving a call from a remote switch to a voice mail group number for a mobile party registered in the remote switch comprises extracting a called subscriber number from the call.

20. A method as set forth in claim 16, where the remote switch is a switch in another country.

21. A method as set forth in claim 16, where the remote switch is a switch operated by another carrier.

22. A method for re-routing a call received from a remote switch to a local voice mail group number for a mobile party registered in the remote switch, comprising:
receiving the call from the remote switch to the voice mail group number for a mobile party registered in the remote switch;
encountering a trigger detection point responsive to a call from a remote switch to a voice mail group number;
in response to the trigger detection point, invoking an intelligent network service dialog for a previously-invoked intelligent network service;
in response to the intelligent network service dialog, issuing instructions to tear down the call from the remote switch;
executing the instruction to tear down and relinquishing the intelligent network service dialog; and
in response to the previously-invoked intelligent network service, executing a call to the voice mail group number.

23. A method as set forth in claim 22, where receiving the call from the remote switch to the voice mail group number for a mobile party registered in the remote switch comprises extracting a called subscriber number from the call.

24. A method as set forth in claim 22, where the remote switch is a switch in another country.

25. A method as set forth in claim 22, where the remote switch is a switch operated by another carrier.

26. A system, comprising:
a service control point comprising means for providing an intelligent network service;
at least one switch comprising means for providing an intelligent network switching capability; and
a plurality of trigger detection points, each comprising means to invoke the same intelligent network service.

27. A system as set forth in claim 26, where the switch is a service switching point.

28. A system as set forth in claim 26, where the switch comprises a mobile switching center.

29. A system as set forth in claim 26, where the service control point and the switch are realized as an intelligent network service node.

30. A system as set forth in claim 26, where
the switch comprises means for call processing; and
the system further comprises at least one event detection point for suspending call processing.

31. A system as set forth in claim 30, where the event detection point for suspending call processing comprises an event detection point for the condition “release,” reason “busy.”

32. A method for managing a call invoking intelligent network service in a telecommunications system, comprising establishing a plurality of trigger detection points for the same intelligent network service.
